(19) United States
(12) Patent Application Publication
(10) Pub. No.: US 2013/0275688 A1
(43) Pub. Date: Oct. 17, 2013

(54) DATA PROCESSING DEVICE AND METHOD

(71) Applicant: SONY CORPORATION, Tokyo (JP)

(72) Inventor: Yu LUO, Pudong New Area Shanghai (CN)

(73) Assignee: Sony Corporation, Tokyo (JP)

(21) Appl. No.: 13/855,289

(22) Filed: Apr. 2, 2013

(30) Foreign Application Priority Data
Apr. 13, 2012 (CN) 201210109513.7

(51) Int. Cl. G06F 12/02

(52) U.S. Cl. CPC G06F 12/02
USPC 711/154

(57) ABSTRACT

The embodiment of the invention provides a data processing device and method and computer system. The data processing device is configured to process a source program to generate a first data segment, wherein, the first data segment comprises a first group of code segment corresponding to the source program, the first group of code segment is constituted by a plurality of code segments, and each code segment of the first group of code segment is stored at an assignable address in the storage medium. With the data processing device and method and computer system according to the embodiment of the invention, an assignable storage of respective code segment generated by parsing the source program is implemented so as to facilitate the access and processing of the computer system

### BACKGROUND

The invention relates to the field of computer system, and more specifically, to a data processing device and method and a computer system.

A NVRAM (Non-Volatile Random Access Memory) is a RAM (Random Access Memory) capable of holding data after power-off, i.e., a RAM in which the stored data is not lost after power-off. A RAM that is opposite thereto includes SRAM and DRAM (it is also divided into SDRAM, DDR SDRAM, DDR2 SDRAM, RDRAM, Direct RDRAM, etc.) in which the information is lost after power-off.

And, the NVRAM being a RAM can be accessed randomly, i.e., when the data in such memory is read or written, the time required is irrelevant to the position where this piece of information is. On the contrary, when the information in sequential access storage apparatus is read or written, the time required is related to the position (for example, in a Magnetic Tape). Therefore, such RAM has almost the fastest speed of reading and writing in all of the access apparatuses, the access delay thereof appears negligible compared to other storage apparatus related to mechanical operation.

In the current computer system, since memory is a storage apparatus mounted on the mainboard directly which communicates with the CPU directly and for storing data, it needs a certain access speed, and it generally adopts a RAM.

Based on the characteristic of the NVRAM, the storage speed thereof can reach about 100 MHz, which is approximate to that of the conventional memory, for example the storage speed of the SDRAM (about 133 MHz), and, the NVRAM can still hold the data stored in case of power-off. Therefore, due to the characteristics of non-off in case of power-off and random access of the NVRAM, it has a stronger expansibility than the conventional memory, and its customizable degree is higher.

In the current computer system, there is a kind of data to be executed by the Operating System, and this kind of data can also be referred to as an executable file. The executable file is generally constituted in the form of code segment+data item, the Operating System reads the code segment in the data and executes it, and reads data item and performs corresponding processing by executing the code segment, and an application is a typical example of this kind of data. Of course, there may be only the code segment for certain type of data without corresponding data item. For this kind of data, since it is constituted in the form of code segment+data item, it is just constituted by integrating the code and data together and stored in a corresponding storage medium.

With the increasingly widespread use of NVRAM, there is the need of a data processing scheme applicable to such new storage medium.

### SUMMARY

Therefore, the invention is made in view of the problem and need existing in the above-described related art.

The objective of the embodiment of the invention is to provide a data processing device and method and a computer system that are capable of implementing assignable storage of respective code segments generated by parsing the source program so as to facilitate the access and processing of the computer system.

According to an aspect of the embodiment of the invention, there provides a data processing device configured to process a source program to generate a first data segment, wherein, the first data segment comprises a first group of code segments corresponding to the source program, the first group of code segments is composed by a plurality of code segments, and each code segment in the first group of code segments is stored at an assignable address in a storage medium.

The described data processing device comprises: a compiling unit configured to parse the source program to generate the first data segment, wherein, the compiling unit specifies only an offset address for each code segment in the first group of code segments; and a storing unit configured to store each code segment in the first group of code segments in the storage medium according to the offset address specified for each code segment by the compiling unit.

In the described data processing device, the compiling unit is configured to modify a load script, set a position unrelated code for each code segment, and specify an offset address for each code segment.

In the described data processing device, the first data segment further comprises a first data item associated with the first group of code segments; and the compiling unit is configured to only specify an offset address for the first data item; the storing unit is configured to store the first data item in the storage medium according to the offset address specified for the first data item by the compiling unit.

The described data processing device further comprises: an encapsulating unit configured to encapsulate the first data item and the first group of code segments together integrally; wherein, the storing unit is configured to store the first data segment encapsulated together integrally in the storage medium according to the offset addresses specified for the first group of code segments and the first data item by the compiling unit.

In the described data processing device, the compiling unit is further configured to comprise: a code modifying module configured to process the source program to generate a second group of code segments by modifying the key words in the load script, wherein, the constitutions of the first group of code segments and the second group of code segments are not identical completely.

In the described data processing device, the second group of code segments comprises at least a valid code segment associated with the processing of the first data item.

In the described data processing device, the encapsulating unit specifies a key value for the first group of code segments or the second group of code segments to protect the access of the first data item.

In the described data processing device, the encapsulating unit adds a micro-thread tag to the first group of code segments or the second group of code segments to specify them as micro-thread level, and the first group of code segments or the second group of code segments and the first data item are processed by a core in a multi-core computer according to the micro-thread tag.

In the described data processing device, the first data item is a video file, and the first group of code segments or the second group of code segments comprises a codec and a key related to the video file.

According to another aspect of the embodiment of the invention, there provides a data processing method for processing a source program to generate a first data segment, wherein, the first data segment comprises a first group of code segments corresponding to the source program, the first group of code segments is composed by a plurality of code segments, and each code segment in the first group of code segments is stored at an assignable address in a storage medium.

The described data processing method comprises: parsing the source program to generate the first data segment, wherein, only an offset address is specified for each code segment in the first group of code segments; and storing each code segment in the first group of code segments in the storage medium.

In the described data processing method, the step of parsing the source program to generate the first data segment is specified as: setting a position unrelated code for each code segment by modifying a load script and specifying the offset address for each code segment.

In the described data processing method, the first data segment further comprises a first data item associated with the first group of code segments; and the step of parsing the source program to generate the first data segment further comprises: specifying only the offset address for the first data item; the step of storing each code segment in the first group of code segments in the storage medium further comprises: storing the first data item in the storage medium according to the offset address specified for the first data item.

In the described data processing method, after the step of parsing the source program to generate the first data segment and before the step of storing each code segment in the first group of code segments in the storage medium, it further comprises: encapsulating the first data item and the first group of code segment together integrally; wherein, the step of storing each code segment in the first group of code segments in the storage medium is specified as: storing the first data segment encapsulated together integrally in the storage medium according to the offset address specified for the first group of code segments and the first data item.

In the described data processing method, the step of parsing the source program to generate the first data segment further comprises: processing the source program to generate a second group of code segments by modifying the key words in the load script, wherein, the constitutions of the first group of code segments and the second group of code segments are not identical completely; and the step of encapsulating the first data item and the first group of code segments together integrally is specifically: encapsulating the first data item and the second group of code segments together integrally.

In the described data processing method, the second group of code segments at least comprises a valid code segment associated with the processing of the first data item.

In the described data processing method, the step of encapsulating the first data item and the first group of code segments or the second group of code segments together integrally further comprises: specifying a key value for the first group of code segments or the second group of code segments to protect the access of the first data item.

In the described data processing method, the step of encapsulating the first data item and the first group of code segments or the second group of code segments together integrally further comprises: adding a micro-thread tag to the first group of code segments or the second group of code segments to specify them as micro-thread level, and processing the first group of code segments or the second group of code segments and the first data item by a certain core in a multi-core computer according to the micro-thread tag.

In the described data processing method, the first data item is a video file, and the first group of code segments or the second group of code segments comprises a codec and a key related to the video file.

According to another aspect of the embodiment of the invention, there provides a computer system, comprising: a controller configured to process the source program to generate a first data segment, wherein, the first data segment comprises a first group of code segments corresponding to the source program, the first group of code segments is composed by a plurality of code segments, and each code segment in the first group of code segments is stored at an assignable address in a storage medium.

By using the data processing device and method and the computer system according to the embodiment of the invention, an assignable storage of respective code segments generated by parsing the source program is implemented so as to facilitate the access and processing of the computer system.

### BRIEF DESCRIPTION OF THE DRAWINGS

For explaining the technical solution in the embodiment of the invention or in the related art more clearly, the figures necessary in the description of the embodiment or the related art are explained simply as follows. It is obvious for those skilled in the art that the figures in the following description are only some embodiments of the invention, and other figures can be obtained from these figures without inventive work.

FIG. 1 is a schematic diagram of the execution of the application process in the computer system;

FIG. 2 is a schematic diagram illustrating the storage state of the respective code segments of the executable file when it is executed in the current computer system;

FIG. 3 is a schematic diagram illustrating the storage state of the respective code segments after being processed by the data processing device according to the embodiment of the invention;

FIG. 4 is a schematic block view of the data processing device according to the embodiment of the invention;

FIG. 5 is a schematic flow chart of the data processing method according to the embodiment of the invention.

### DETAILED DESCRIPTION

Hereinafter, the data processing device and method and the computer system according to the embodiment of the invention will be described specifically in combination with the accompanying drawings.

As mentioned before, the data needed to be executed by the Operating System in the current computer system is generally constituted in the form of code segment+data item, and such data may be also referred to as an executable file. Hereinafter, the code segment in such executable file is abbreviated as code, and the data item is abbreviated as data, and the integrity constituted by the code segment and data item is called as data segment at times. In the current computer system, ELF is a standard format of the executable file of the system, the executable file in ELF format may have a plurality of logical segments.

In the current computer system, the ELF file mainly has three different forms:

Relocatable: generated by the compiler and the assembler, and processed by the linker;

Executable: all of the relocation and symbol parsing have been finished, maybe the symbol of the shared library is parsed as being executed;

Shared Object: including the symbol information needed by the linker and the code needed as being executed.

The file has a dual nature: on the one hand, all of the compiler, the assembler and the linker regard it as a set of logical segments, and on the other hand the loader regards it as a set of segments. The logical segment is further processed by the linker, and the segment is mapped into the memory. How the system creates a memory map of one routine is determined by a program header table, and one segment may be constituted by several logical segments. For locating different segments/logical segments, the executable file records positions and descriptions of respective segments/logical segments using one table, one logical segment header table including the information of respective logical segments of the descriptive file. Each logical segment has an entry in this table, and each entry presents information such as name and size of the logical segment or the like. The ELF file in relocatable form has a logical segment header table, the ELF file in executable form has a program header table, and the ELF file in shared object form has both tables.

Hereinafter, the implementation of the executable file is explained. As aforementioned, the application is a typical example of such executable file, and hereinafter it is explained by taking an application as example. And, hereinafter, the above compiler, assembler and linker are collectively referred to as a compiling part.

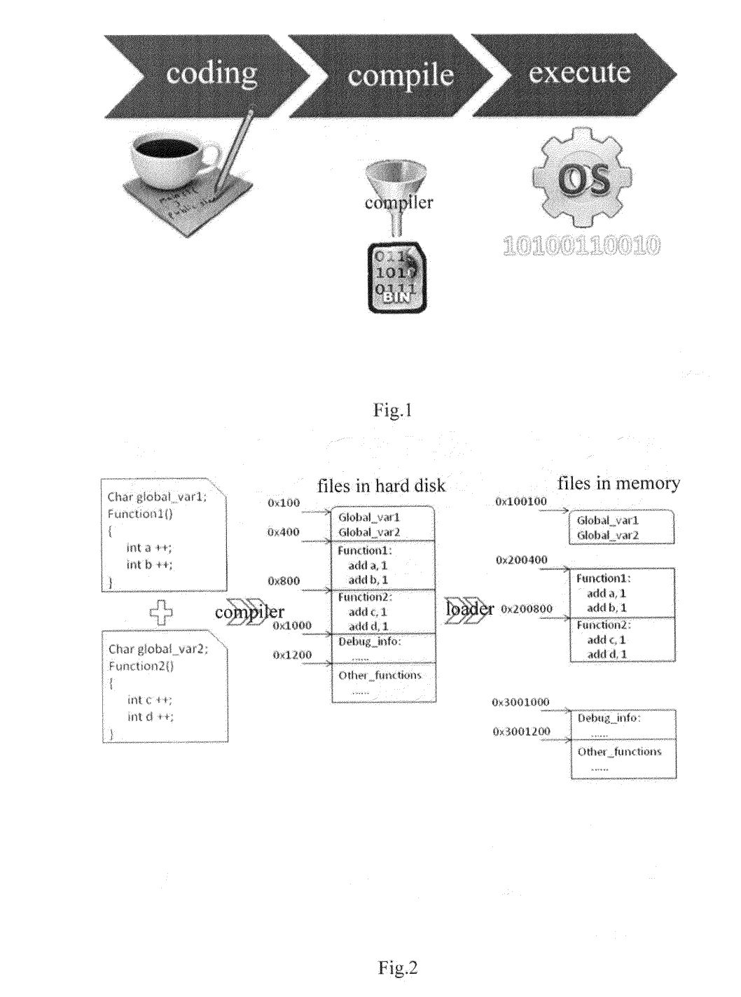

As shown in FIG. 1, in programming of the application, the programming staff completes the source program in various languages, and they are compiled by the compiling part of the computer system, so as to be executed in the form of binary data in the operating system. As mentioned before, the compiling part means the combination of the compiler, assembler and linker. FIG. 1 is a schematic diagram of the execution of application process in the computer system. Here, those skilled in the art can understand that it may only include the code executed by the operating system rather than the data and it can include both of the code and data for application.

Hereinafter, the storage state of the respective code segments of the executable file in the storage medium when the executable file is executed in the current computer system is described in detail with reference to FIG. 2. FIG. 2 is a schematic diagram illustrating the storage state of the respective code segments of the executable file when it is executed in the current computer system; As shown in FIG. 2, the source program of the executable file composed by the programming staff is stored in non-volatile storage devices such as a hard disk after being compiled by the compiling part, the procedure of compiling by the compiling part is generally referred to as “parsing”, and hereinafter, the executable file stored on the hard disk is also referred to as an input file. In the procedure of parsing, the compiling part parses the respective functions in the source program into the corresponding code, and such code may be constituted by a plurality of code segments, and, the compiling part also adds some additional code segments in addition to the code segments corresponding to the functions in the source program, to generate the object file including a code segment group constituted by a plurality of code segments (it may also include data item). Further, the compiling part joints the respective object file generated together, and specifies the storage address of the respective code segment (optionally, data item) in the hard disk and the memory. In the added code segment, it includes the code segment related directly to the function of the source program, and in case that it includes data item, it includes the code segment related to the data item, these code segments are collectively referred to as valid code segments or functional code segments. And, in the code segment added, it may further include auxiliary code segments unrelated to the function of the source program and the data item but utilized by the computer system, for example, debug code segment, global code segment, init code segment and deinit code segment or the like.

In the current computer system, the respective code segments are generated by the ldscript (load script) module in the compiling part, these code segments are the logical segments, there hold function and data and control information of the source program in the different code segments, hereinafter it lists some auxiliary code segments utilized by the computer system, and indicates the types and attributes of these code segments:

.data: this code segment holds initialized data, which exists in the memory map of program;

.comment: this code segment holds the version control information;

.init: this code segment holds executable instruction, it constitutes the initialization code of the routine, therefore, when a program starts to run, the system arranges to execute the code in this code segment before the principal function (it is called main function in C language) is called;

.text: this code segment holds “text” or so-called executable instruction of the program;

.dynamic: this code segment holds the information of dynamic link;

.dtnstr: it holds the character string required for dynamic linking;

.dynsym: it holds the description of the dynamic symbol table such as “symbol table”;

.rel<name> and sela<name>: they hold the information of relocation.

Then, as shown in FIG. 2, when the Operating System needs to execute the input file stored in the hard disk, it applies the loader to load the input file into the memory, hereinafter, the executable file stored in the memory is also referred to as an output file.

In the computer system, when one routine map from an input file to an output file is created or added, in principle, the respective code segments of the input file are copied to the virtual space of the memory to form the output file. However, as mentioned before, in the procedure of parsing, the compiling part also specifies the actual address of each code segment (optionally, data item) loaded into hard disk and memory in addition to completion of the task of jointing the respective object files together.

The ldscript will specify a base address and an offset address for a respective code segment after creating the respective code segment, wherein, the offset address refers to the storage address of the respective code segment in the hard disk, and the base address+offset address refer to the storage address of the respective code segment in the memory. Thus, for the input file stored in the hard disk, it follows the offset address specified for each code segment by the ldscript, so that the respective code segment and the corresponding data item after being parsed can be stored at the specified address in the hard disk.

Further, the compiling part has its own set of language norm, and its purpose is to describe how the code segment in the input file is mapped into the output file, and to control the arrangement of the output file in memory, this set of norm is embodied in the ldscript, and is built in the compiling part, the loader uses this set of language norm to generate the output file.

Based on the contents mentioned before, each input file has a list of code segments, one code segment may be marked as loadable, which means the output file can load this code segment into memory as being executed, and the code segment without any content may be referred as allocatable, which means this region may be placed at some place in the memory, but there is not anything special placed therein (it is generally initialized to 0).

In the object file, the output code segment of loadable or allocatable has two kinds of addresses: VMA (Virtual Memory Address) and LMA (Load Memory Address). VMA is the address at which the code segment is as executing the output file, i.e., the address of the output file in the memory in FIG. 2, and LMA is the address of the code segment when the output file is being loaded, i.e., the address of the output file in the hard disk in FIG. 2. In general, the VMA and LMA of a certain code segment is identical. However, in the embedded system, there is often the case that the load address and execute address are different: for example, the output file is loaded to the flash of the develop board (it is specified by the LMA), and the output file in the flash is copied to the SDRAM as being executed (it is specified by the VMA).

When the loading procedure of the loader is executed to execute the routine map from the input file to the output file, for the above-described input file stored in the hard disk in the form of code segment (or code segment+data item), the loading procedure does not store the respective code segments at the specified address in the memory according to the base address+offset address specified for the respective code segments by the ldscript, instead, it changes the base address of the respective code segments, so that these code segments can't be stored at the specified address in the memory, thus, the respective code segments after being loaded are not stored at the position of base address+offset address as specified by the ldscript, but stored at disperse addresses in the memory. Therefore, the loading procedure of the loader actually changes the base address specified for the respective code segments by the ldscript, so that the respective code segments being loaded into the executable file in the memory are not able to be stored at the specified address in the memory.

This is because when an output file is generated, for the set of code segments constituted by a plurality of code segments, the compiling part regards it as the set of logical segments, and the loader regards it as the set of segments, and the compiling part and the loader interprets the difference between the logical segments and the segments from a different point of view. For example, it assumes that a program segment starts from address 0, and the loader would give the last address to this program segment so that different program segments does not overlap with each other, and, in the loading procedure, the loader would move the program segment to the respective address at the time of being executed, i.e., the above-described VMA. That is, when the loader loads the application, it also specifies the address at time of being executed of the code segment, and this procedure is referred to as relocation.

Therefore, due to the potential difference between the VMA and the LMA, when the code segment stored at the address specified by the compiling part in the hard disk is stored in the memory, it can't be stored with the above-described specified address. After relocation, the plurality of executable code segments to be read would be stored randomly at disperse address in the memory. However, in the current computer system, the output file is temporarily stored in the memory, and the procedure of the operating system executing the input file stored in the hard disk is an integral procedure, the output file is executed directly after the loader loads the input file, therefore, the storage mode would not cause any significant problem. And, since it is in the actual executing procedure of the input file, it does not need each code segment to be stored at a consecutive assignable address in the memory, and it can fulfill the execution of the code segment according to the address index of each code segment in the executing procedure, such dispersive storage mode would not cause any influence on the continuity of the execution of the code segment.

However, when it is in the new storage medium such as NVRAM or the like, if a plurality of code segments corresponding to the same data item is stored at dispersive address in an uncontrollable random form, it is obviously disadvantageous for the access and processing of the data by the Operating System. Therefore, in the new storage medium such as NVRAM, since the Operating System may not need the loader to read and execute the executable file such as application from NVRAM, a new data processing scheme is needed to facilitate the access and process of the stored data by the Operating System.

Therefore, according to the embodiment of the invention, there provides a data processing device for processing the source program to generate a first data segment, wherein, the first data segment comprises a first group of code segments corresponding to the source program, the first group of code segments is composed by a plurality of code segments, and each code segment is stored in a storage medium at an assignable address.

In the data processing device, the source program refers to the data composed by the programming staff without being compiled by the compiling part, and as mentioned before, it is the executable file which is executable by the Operating system of computer such as application. And, the first data segment is the data stored in the storage medium such as memory and NVRAM, and it can be executed by the operating system without being loaded by the loader of the operating system, that is, it corresponds to the output file stored in the memory after being loaded by the loader in the current computer system, and it is different from the input file stored in the hard disk after being compiled by the compiling part and being loaded by the loader in the current computer system.

Therefore, with the data processing device according to the embodiment of the invention, the dispersive and non-assignable storage mode of the respective code segments in the storage space of the memory, for example, can be changed, so that each code segment in a group of code segment is stored at an assignable address in the storage space to facilitate the access and processing of the computer system.

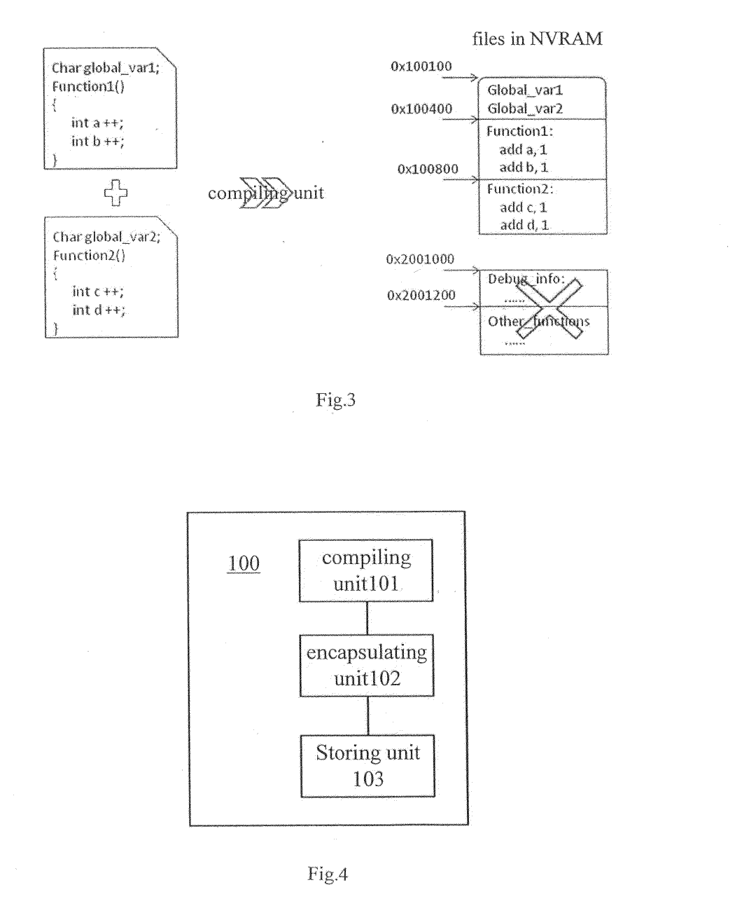

As shown in FIG. 3, the respective code segments after being processed by the data processing device according to the embodiment of the invention have the assignable base address+offset address so as to be stored at specified address in the storage space such as NVRAM. Here, those skilled in the art can appreciate that, each code segment in the first group of code segment in the first data segment can be specified consecutive offset addresses if necessary, so that the first data item and each of the corresponding code segment are stored at consecutive addresses in the storage space. FIG. 3 is a schematic diagram illustrating the storage state of the respective code segments after being processed by the data processing device according to the embodiment of the invention.

As mentioned before, in the current computer system, it is the compiling part that adds corresponding code segment to the data item, and specifies the base address and the offset address in the hard disk and memory for each code segment. Therefore, the data processing device according to the embodiment of the invention comprises a corresponding compiling unit to carry out code and data integration to the source program.

In particular, the data processing device according to the embodiment of the invention comprises: the compiling unit for parsing the source program to generate the first data segment, wherein, only an offset address is specified for each code segment in the first group of code segments; and the storing unit for storing each code segment in the first group of code segments in the storage medium according to the offset address.

As mentioned before, in the current computer system, when the loading procedure is executed by the loader of the Operating System, due to the relocation process in the executing procedure, the base address of the input file loaded would be modified so that the respective code segment are stored at dispersive and non-assignable address in the memory. On the contrary, in the code and data integrating device according to the embodiment of the invention, only the offset address is specified for each code segment by the compiling unit without specifying the base address, so that the relocation process in the loading procedure does not specify an address that is different from the address as loading for the code segment, and each code segment is stored at specified offset address in the storage space.

In the data processing device according to the embodiment of the invention, the compiling unit can be implemented by modifying the ldscript program of the compiling part in the current computer system, that is, by modifying the ldscript program of the conventional compiling part to specify only offset address for each code segment in the first data segment without specifying the base address, the respective code segments are stored at assignable offset address in the storage space.

In the specific implementing procedure, by modifying the text in the ldscript to set position unrelated code for each code segment and specifying the offset address for each code segment, the ldscript is made to specify only the offset address for the respective code segments.

As mentioned before, the ldscript is a script for describing how the respective code segments in the input file are mapped to the output file and control the arrangement in the memory of the output file. For clarity, there provides example of the simplest script, it only comprises command about one code segment, and describes the arrangement in the memory of the output file:

SEGMENTS

| | |
|---|---|
| { | |
| .=0x100100; | /* the code is loaded into this address */ |

.text SIZEOF_HEADERS:{

| | |
|---|---|
| *(.init) | /* the code placed in the init segment */ |
| *(.text) | /* the code placed in the text segment */ |
| *(.fini) | /* the code placed in the fini segment */ |

| | |
|---|---|
| } | |
| .=0x8000000; | /* the data is loaded into this address */ |
| .data:{*(.data)} | |
| .bss:{*(.bss)} | |
| } | |

In the said script, the address of the variable defined can be modified, here, the symbol defined in the input file can be assigned a value in the script, at this time, the symbol is defined as global, and each symbol corresponds to an address, assigning value means changing the address corresponding to the symbol.

Thus, position unrelated code can be added in the above-described script, so that the ldscript sets the position unrelated code for each code segment and specifies the offset address for each code segment. The basic idea of the implementation of the position unrelated code technology is to separate the part needed to be modified by relocation in the instruction so that each routine has a duplicate.

Based on the above-mentioned, in the data processing device according to the embodiment of the invention, it is considered that the compiling unit executes the combination of the function of the compiling part and the function of the loader in the current computer system, and the general idea of the data processing device according to the embodiment of the invention is to reintegrate the respective code segment for the source program composed by the programming staff to generate a program in a format that needs not to be loaded and can be executed directly as in the memory in the related art.

The compiling unit in the data processing device according to the embodiment of the invention can be implemented by modifying the loader of the Operating System in the current computer system so that the relocation process does not change the base address of the respective code segment in the loading procedure so as not to randomly assign the base address of the respective code segment stored in the memory, but to specify the storage address in the memory for the respective code segment. In the current computer system, since the loader of the Operating System is used for various kinds of application, for generality, the said relocation process is employed to modify the storage address of the respective code segments in the memory. Therefore, the loader of the Operating System can be limited to be dedicated to a certain type of a specific application, thus, the above-described relocation process would not modify the base address specified by the ldscript of the respective code segments, so as to implement the function of storing the respective code segments at the specified address in the storage space.

In the data processing device according to the embodiment of the invention, the first data segment can further comprise the first data item associated with the first group of code segments, and the compiling unit only specify the offset address for the first data item, and the storing unit stores the first data item to the storage space according to the offset address.

As mentioned before, the way of implementation of specifying only the offset address without specifying the base address for the first data item may be same as that about the code segment mentioned above, and here will no longer give unnecessary details. For example, in the example of loading script as mentioned above, it also includes the description of the address into which the data is loaded, and it can specify only the offset address by adding the position unrelated code, or, the relocation process is made not to modify the previously specified base address for the data item by modifying the loader.

The data processing device according to the embodiment of the invention further comprises an encapsulating unit for encapsulating the first data item and the first group of code segments together integrally.

As mentioned before, the linker in the compiling part joints the respective code segments generated by compiling the source program together, when a data item corresponding to a group of code segments is included, it joints the data item and the corresponding group of code segments together. However, in the loading procedure of the loader, the respective code segments and data item will be relocated. On the contrary, in the data processing device according to the embodiment of the invention, by specifying the offset address for the respective code segments and the corresponding data item, the data item and the corresponding respective code segment are encapsulated together integrally, for example, they are stored at consecutive address in the storage medium, or there are continuous indices specifying the code segment and the data item, thus, the integral encapsulation in the level of memory of the code segment and the data item can be implemented.

In the data processing device according to the embodiment of the invention, the compiling unit can further comprise a code modifying module for processing the source program to generate a second group of code segments, wherein, the constitutions of the first group of code segments and the second group of code segments are not completely identical.

In the current computer system, when the operating system executes program, it is the loader that loads all of the dynamic link libraries to the routine address space, binds the undetermined symbol in the program to the corresponding DLL, and executes the relocation operation.

In the above code segments generated by the ldscript, several code segments of .dynamic, .dtnstr, .dynsym, sel<name> and.rela<name> are mentioned, these are the key words for generating the DLL in the script, in the procedure of modifying the constitution of the code segments, it needs to ensure generation of a new group of code segments like DLL, and it can't generate the auxiliary information of the loader such as .dynamic.

As mentioned before, in the data processing device according to the embodiment of the invention, the addresses of the code segment and the optional bound data item can be specified, since there is not the participation of the loader, it must generate code with good self-organization. As mentioned before, the ldscript has organized the code group into the format recognizable by the loader as generating the DLL, this is mainly implemented by depending on some dynamic link supplementary information, and these information would hinder the recognition of the code without the participation of the loader. Therefore, in the data processing device according to the embodiment of the invention, the code generated by the ldscript can be further simplified, so as to remove unnecessary code segment and supplementary information.

In the data processing device according to the embodiment of the invention, for modifying the code segment constituting the code segment group, as mentioned before, since each code segment is expressed by the key words in the script of the ldscript program, the constitution of the group of code segments can be modified by modifying these key words. Here, those skilled in the art can understand, the modification for the code segment is not limited to removing unnecessary code segment, which is mentioned before, it may add code segment and modify the type and attribute or the like of the code segment if necessary, the embodiment of the invention is not intended to make any restriction.

And, in case that the first data segment is constituted by the first group of code segments and the first data item, since the Operating System needs to access and process the data by processing the code, the second code segment comprises at least the functional code segment related to the first data item.

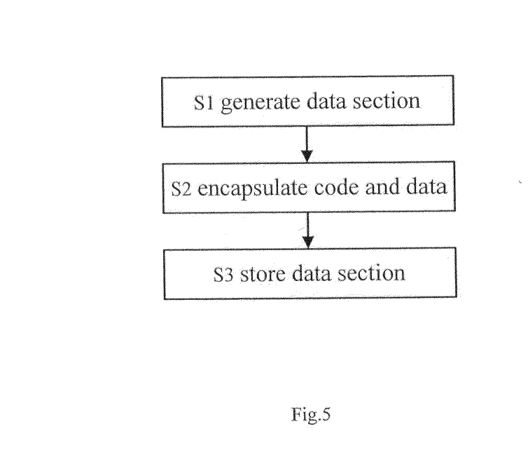

FIG. 4 is a schematic block view of the data processing device according to the embodiment of the invention. As shown in FIG. 4, the data processing device 100 according to the embodiment of the invention comprises: a compiling unit 101 for processing the source program to generate the first data segment, the first data segment comprises a first group of code segments corresponding to the source program and a first data item corresponding to the first group of code segments, the first group of code segments is constituted by a plurality of code segments, and the compiling unit 101 specifies only the offset address for each code segment in the first group of code segments and the first data item, for encapsulating the first group of code segments and the first data item generated by the compiling unit 101 together integrally; and a storing unit 103 for storing each code segment in the first group of code segments and the first data item encapsulated together by the encapsulating unit 102 in the storage medium according to the offset address specified by the compiling unit 101.

With the described data processing device according to the embodiment of the invention, it can carry out code and data integration to the source program to generate new data, such data is constituted by the code segment and the data item, and the Operating System carries out corresponding operation by executing the program code in the code segment, and read and execute the data item associated with the code segment. In the embodiment of the invention, the code generated in the above-described manner (it may be the above-described first group of code segments, and may be the above-described second group of code segments) can be referred to as tinycode, it is substantially a small code fragment per se, and has no difference from other code, and the position thereof is bound to the specific data associated therewith together. Substantially, in the first data generated by the data processing device according to the embodiment of the invention, it can define arbitrarily the position of the tinycode in the first data, it may be placed in the most front end of the data segment of the first data, and may be placed in the rearmost end of the data segment of the first data, depending on the compiling unit.

Actually, in the current computer system, there also mentions the concept of binding the code and data together, for example, data oriented programming language such as C++ has mentioned this idea, i.e., data encapsulation. However, actually for the programming languages, such data encapsulation in language level is determined by the compiler, but as mentioned before, in the random access memory such as memory, such mechanism is not implemented. In case that the computer system employs a fast NVRAM device, by employing the data processing device according to the embodiment of the invention to carry out code and data integration to be stored in NVRAM, it can obtain a series of advantages.

For the current fast NVRAM device, the manufacturer generally either used it to store data as purely SD card or execute program as pure DRAM. Though these two kinds of ways can accelerate reading of the data and access to the program, from the perspective of security, if a piece of data is placed simply in the fast NVRAM, it is easy to be deciphered, and if it is encrypted with a piece of program using the theory of key, it may unlock the data, but the encryption and decryption of the data needs the computation of CPU, it is easy to form performance bottleneck.

And, in the conventional scheme, since the program and the data are separate from each other, if the program is bypassed, the data can still be accessed, and this is also very unsafe.

With the data processing method according to the embodiment of the invention, a complete encapsulation of the code and data can be implemented so as to achieve the purpose of protecting data easily. For example, in the embodiment of the present invention, each tinycode can be specified a key value by own, and it is set that program calling this tinycode has to obtain a correct key value to access data, thus, since the tinycode and the data is encapsulated integrally, the program can't access the data without obtaining the key value, so as to improve the security of the data. Here, the key value may be specified by the programmer/administrator creating the data, and, if it is for easy access, the key value may not be set; the embodiment of the invention is not intended to make any restriction.

In the current computer system, with the continuous development of the computer hardware technology, the multi-core computer is employed to process data more and more frequently; the data segment generated by the data processing device according to the embodiment of the invention can facilitate the parallel access of multi-core. In the data segment generated by the data processing device according to the embodiment of the invention, each data segment has its own tinycode, and when the compiling unit compiles these tinycodes, it can implicitly specify these codes as micro-thread level, thus, the programmer does not need to explicitly write multi-thread code. Thus, when the multi-core computer executes these codes, the main thread would find that a certain function has such micro-thread tag, thus the tinycode with such micro-thread tag would be assigned to be executed by a certain core, and continue to execute the subsequent code itself, so as to achieve multi-core acceleration. In this way, the programmer does not need to participate in too much detail, the multi-core computer can process automatically, and each core accesses the data automatically without interfering with each other, so as to facilitate the convenience of the user and improve the performance of the access and processing of the computer system.

In an application example of the data processing device according to the embodiment of the invention, the code and data integration scheme of the embodiment of the invention can be applied to the video playback file, i.e., the data item is set as video data, and the code segment associated with the data item is the codec used for the video data, so as to enhance the copyright protection of the video producer. In particular, when the video producer provides the video file to the developer of the video player, he can encapsulate the video data and the corresponding codec and key (as tinycode) integrally, so as to authorize the developer of the video player to playback the video file. Thus, the developer of the video player does not need to continuously update various codec of different video format as in the current instance, but only focus on the graphical user interface (GUI) and other functions of the video player, for example, the function of calling the codec and parsing the document, it can alleviate the burden of the developer of the video player. And, in this case, the user does not need to mount many plug-ins of the video player to parse video stream of different formats as in the current situation, so as to alleviate the burden of the user. At the same time, since the developer of the video player needs the corresponding codec and key to parse the video data, ordinary user without the key is incapable of reading the video file, and is incapable of knowing how to call the tinycode, it can protect the copyright of the video producer efficiently.

The detailed implementing procedure of the data processing device according to the embodiment of the invention is described as follows.

First, for example, the programmer A writes a piece of code a_code (for example, the code for decoder), it can read the data file of type A (for example, an AV file); then, the data processing device according to the embodiment of the invention processes the code of this piece of source program to generate the corresponding code segment, i.e., tinycode; then, the tinycode and the data file of type A is jointed together by using the file jointing tool such as such command of copy+b to generate data segment A′, and stores it in the storage medium such as NVRAM.

As accessing and processing the above-described generated data A′, another developer B writes a code b_code for calling a_code to access the data file of type A. For example, in this procedure, the way of calling a_code is as follows:

1) open(A′) (this is the same as the way of opening the ordinary document, and, here is the processed data segment A′ instead of the original data file A);

2) read(A′)→buffer

Wherein, the header address of the buffer is the address of the function, the developer B calls this function (decoder) according to the explanation manual to parse the subsequent file (it assumes the developer B has the copyright of this document), and, since one data file corresponds to a piece of tinycode, the developer B can't open other file of type A, which have no copyright.

For contrast, the comparative example in the current computer system is described as follows:

First, the programmer A writes a piece of code a code (for example, the code of decoder), it can read the data file of type A (for example, a AV segment), then he compiles this piece of code to generate a DLL a_lib (here the joint file is not needed).

Another developer B writes b_code for calling the a_code to access the data file of type A. For example, in this procedure, the way of calling a_code is as follows:

1) dlopen (a_lib) (wherein, dlopen belongs to a kind of loader, and it is different from the open function of the above-described embodiment of the invention);

2) the a_code is found in the a_lib according to for example the manual of video standard, and then it is called to parse the file of type A, here, if there are plurality of files with the same type, all of them can be read, that is, in this case, the code and the data are substantially separated.

Here, those skilled in the art can understand, though in the above description, it mainly explains by taking the NVRAM as the example of the storage medium, the processed data by the data processing device according to the embodiment of the invention is also adapted to be stored in the storage medium of other types to be accessed and processed by the Operating System of the computer without the loading procedure of the loader of the Operating System. In the above case, the procedure that the Operating System accesses and process the processed data by the data processing device according to the embodiment of the invention is similar to the procedure of accessing and processing the data stored in the memory in the related art, and it would not be described for avoiding redundancy.

According to another aspect of the embodiment of the invention, there provides a data processing method for processing the source program to generate a first data segment, wherein, the first data segment comprises a first group of code segments corresponding to the source program, the first group of code segments is composed by a plurality of code segments, and each code segment in the first group of code segments is stored in a storage medium at an assignable address.

The described data processing method comprises: parsing the source program to generate the first data segment, wherein, only an offset address is specified for each code segment in the first group of code segments; and storing each code segment in the first group of code segments in the storage medium.

In the described data processing method, the step of parsing the source program to generate the first data segment is specifically: setting a position unrelated code for each code segment by modifying a load script and specifying the offset address for each code segment.

In the described data processing method, the first data segment further comprises a first data item associated with the first group of code segments; and the step of parsing the source program to generate the first data segment further comprises: only specifying the offset address for the first data item; the step of storing each code segment in the first group of code segments in the storage medium further comprises: storing the first data item in the storage medium according to the offset address specified for the first data item.

In the described data processing method, after the step of parsing the source program to generate the first data segment and before the step of storing each code segment in the first group of code segments in the storage medium, it further comprises: encapsulating the first data item and the first group of code segments together integrally; wherein, the step of storing each code segment in the first group of code segments in the storage medium is specified as: storing the first data segment encapsulated together integrally in the storage medium according to the offset address specified for the first group of code segments and the first data item.

In the described data processing method, the step of parsing the source program to generate the first data segment further comprises: processing the source program to generate a second group of code segments by modifying the key words in the load script, wherein, the constitutions of the first group of code segments and the second group of code segments are not identical completely; and the step of encapsulating the first data item and the first group of code segments together integrally is specified as: encapsulating the first data item and the second group of code segments together integrally.

In the described data processing method, the second group of code segments at least comprises a valid code segment associated with the processing of the first data item.

In the described data processing method, the step of encapsulating the first data item and the first group of code segments or the second group of code segments together integrally further comprises: specifying a key value for the first group of code segments or the second group of code segments to protect the access of the first data item.

In the described data processing method, the step of encapsulating the first data item and the first group of code segments or the second group of code segments together integrally further comprises: adding micro-thread tag to the first group of code segments or the second group of code segments to specify them as micro-thread level, and processing the first group of code segments or the second group of code segments and the first data item by a certain core in a multi-core computer according to the micro-thread tag.

In the described data processing method, the first data item is a video file, and the first group of code segment or the second group of code segment comprises a codec and a key related to the video file.

FIG. 5 is a schematic flow chart of the data processing method according to the embodiment of the invention. As shown in FIG. 5, the data processing method according to the embodiment of the invention comprises: S1, processing the source program to generate the first data segment, the first data segment comprises the first group of code segment corresponding to the source program and the first data item corresponding to the first group of code segments, the first group of code segments is constituted by a plurality of code segments, wherein, only the offset addresses are specified for each code segment in the first group of code segments and the first data item; S2, encapsulating the first group of code segments and the first data item generated in S1 together integrally; and S3, storing each code segment in the first group of code segments and the first data item encapsulated together in S2 in the storage medium according to the offset address specified in S1.

Here, other details of the data processing method according to the embodiment of the invention are same as those of the above-described data processing device according to the embodiment of the invention, and it would be described for avoiding redundancy.

According to another aspect of the embodiment of the invention, there provides a computer system, comprising: a controller configured to process the source program to generate a first data segment, wherein, the first data segment comprises a first group of code segments corresponding to the source program, the first group of code segments is composed by a plurality of code segments, and each code segment in the first group of code segments is stored in a storage medium at an assignable address.

With the data processing device and method and the computer system according to the embodiment of the invention, an assignable storage of respective code segments generated by parsing the source program is implemented so as to facilitate the access and processing of the computer system.

Those skilled in the art can understand that, the units and algorithm steps of the examples described in combination with the embodiments disclosed in the specification can be implemented by an electronic hardware, a computer software or both of them, in order to explain the interchangeability of hardware and software clearly, the constitution and step of the respective examples is described generally according to the function in the above explanation. Whether these functions are implemented by hardware or software depends on the specific application of the technical solution and the design restrictions. Those skilled in the art can use different methods to implement the described function for each specific application, and this implementation should not be regarded as beyond the disclosure of the invention.

Those skilled in the art can understand that, for the convenience and simplicity of description, the detailed operational procedure of the above system, apparatus and method can correspond to the corresponding procedure in the method embodiment, and shall not be described any more.

In the several embodiments in the invention, it can understand that the disclosed system, apparatus and method can be implemented by other means. For example, the apparatus embodiment above mentioned is only schematic, for example, the division of the units is only a logical functional division, and there can be other means of division for practical use, for example, multiple units or components can be combined or integrated to another system, or some features can be omitted, or do not operate. Further, the coupling therebetween or the direct coupling or communication connection can be implemented by indirect coupling or communication connection of some interfaces, apparatus and units, and they can be electric, mechanic or in other form.

The units described as separate components may be or may not be physically separated, the components shown as units may be or may not be physical units, i.e., they can be located at a same position, or distributed on a plurality of network units. The object of the solution of the embodiment can be implemented by selecting part or all of the units according to the practical need.

Further, the respective functional units in the respective embodiments of the invention can be integrated in a processing unit, and the respective units can be individual, or two or more of units can be integrated in a unit. The above integrated unit can be implemented by the form of hardware or the form of software functional unit.

If the integrated unit is implemented in the form of software functional unit and sold and used as an individual product, it can be stored in a computer readable storage medium. Based on this understanding, the essential technical solution of the invention or the part contributed to the related art or part or all of the technical solution can be embodied as a software product, and this computer software product is stored on storage medium, includes some instructions to cause a computer (PC, server or networked apparatus, etc.) to perform part or all of the steps of the method of the embodiment of the invention. And the storage medium includes medium storing program code such as U disc, mobile hard driver, ROM, RAM, magnetic disc or optical disc, etc.

The contents mentioned before are only the preferred implementation for carrying out the invention. It should be pointed out that, for those ordinarily skilled in the art, on the condition of not deviating from the principle mentioned in the present invention, several improvements and refinements can be made as well, which should be also treated as the scope protected by the present invention.

1. A data processing device, configured to process a source program to generate a first data segment, wherein, the first data segment comprises a first group of code segments corresponding to the source program, the first group of code segments is composed by a plurality of code segments, and each code segment in the first group of code segments is stored at an assignable address in a storage medium.

2. The data processing device according to claim 1, comprising:
a compiling unit, configured to parse the source program to generate a first data segment, wherein, the compiling unit only specifies an offset address for each code segment in the first group of code segments; and
a storing unit, configured to store each code segment in the first group of code segments in the storage medium according to the offset address specified for each code segment by the compiling unit.

3. The data processing device according to claim 2, wherein
the compiling unit is configured to modify a load script, set a position unrelated code for each code segment and specify the offset address for each code segment.

4. The data processing device according to claim 2, wherein
the first data segment further comprises a first data item associated with the first group of code segments; and
the compiling unit is configured to specify only the offset address for the first data item;
the storing unit is configured to store the first data item in the storage medium according to the offset address specified for the first data item by the compiling unit.

5. The data processing device according to claim 4, further comprising:
an encapsulating unit, configured to encapsulate the first data item and the first group of code segments together integrally;
wherein, the storing unit is configured to store the first data segment encapsulated together integrally in the storage medium according to the offset address specified for the first group of code segments and the first data item by the compiling unit.

6. The data processing device according to claim 5, wherein, the compiling unit is further configured to comprise:
a code modifying module, configured to process the source program to generate a second group of code segments by modifying the key words in the load script, wherein, the constitutions of the first group of code segments and the second group of code segments are not completely identical.

7. The data processing device according to claim 6, wherein
the second group of code segments comprises at least a valid code segment associated with the process of the first data item.

8. The data processing device according to claim 6, wherein
the encapsulating unit specifies a key value for the first group of code segments or the second group of code segments to protect the access of the first data item.

9. The data processing device according to claim 6, wherein
the encapsulating unit adds micro-thread tag to the first group of code segments or the second group of code segments to specify them as micro-thread level, and the first group of code segments or the second group of code segments and the first data item are processed by a core in a multi-core computer according to the micro-thread tag.

10. The data processing device according to claim 6, wherein
the first data item is a video file, and the first group of code segments or the second group of code segments includes a codec and a key related to the video file.

11. A data processing method for processing the source program to generate a first data segment, wherein, the first data segment comprises a first group of code segments corresponding to the source program, the first group of code segments is composed by a plurality of code segments, and each code segment is stored an assignable address in a storage medium.

12. The data processing method according to claim 11, comprising:
parsing the source program to generate the first data segment, wherein, only an offset address being specified for each code segment in the first group of code segments; and
storing each code segment in the first group of code segments in the storage medium according to the offset address specified for each code segment.

13. The data processing method according to claim 12, wherein
the step of parsing the source program to generate the first data segment is specified as:
setting a position unrelated code for each code segment by modifying the load script and specifying the offset address for each code segment.

14. The data processing method according to claim 13, wherein
the first data segment further comprises a first data item associated with the first group of code segments; and
the step of parsing the source program to generate the first data segment further comprises:
specifying only the offset address for the first data item;
the step of storing each code segment in the first group of code segments in the storage medium further comprises:
storing the first data item in the storage medium according to the offset address specified for the first data item.

15. The data processing method according to claim 14, after the step of parsing the source program to generate the first data segment and before the step of storing each code segment in the first group of code segments in the storage medium, it further comprises:
encapsulating the first data item and the first group of code segments together integrally;
wherein, the step of storing each code segment in the first group of code segments in the storage medium is specified as:
storing the first data segment encapsulated together integrally in the storage medium according to the offset address specified for the first group of code segments and the first data item.

16. The data processing method according to claim 15, wherein, the step of parsing the source program to generate the first data segment further comprises:
processing the source program to generate a second group of code segments by modifying the key words in the load script, wherein, the constitutions of the first group of code segments and the second group of code segments are not identical completely; and
the step of encapsulating the first data item and the first group of code segments together integrally is specified as:
encapsulating the first data item and the second group of code segments together integrally.

17. The data processing method according to claim 16, wherein, the second group of code segments at least comprises a valid code segment associated with the processing of the first data item.

18. The data processing method according to claim 16, wherein,
the step of encapsulating the first data item and the first group of code segments or the second group of code segments together integrally further comprises:
specifying a key value for the first group of code segments or the second group of code segments to protect the access of the first data item.

19. The data processing method according to claim 16, wherein,
the step of encapsulating the first data item and the first group of code segments or the second group of code segments together integrally further comprises:
adding micro-thread tag to the first group of code segments or the second group of code segments to specify them as micro-thread level, and
processing the first group of code segments or the second group of code segments and the first data item by a certain core in a multi-core computer according to the micro-thread tag.

20. The data processing method according to claim 19, wherein, the first data item is a video file, and the first group of code segments or the second group of code segments comprises a codec and a key related to the video file.

21. A computer system, comprising:
a controller configured to process the source program to generate a first data segment, wherein, the first data segment comprises a first group of code segments corresponding to the source program, the first group of code segments is composed by a plurality of code segments, and each code segment in the first group of code segments is stored in a storage medium at an assignable address.
